(19) United States
(12) Patent Application Publication
(10) Pub. No.: US 2024/0396007 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/442,317

(22) Filed: Feb. 15, 2024

(30) Foreign Application Priority Data
May 26, 2023 (JP) 2023-086722

(51) Int. Cl. H01M 4/13; H01M 4/02; H01M 10/052; H01M 10/0587

(52) U.S. Cl. CPC H01M 4/13; H01M 10/0587; H01M 2004/021; H01M 2004/027; H01M 2004/028; H01M 10/052

(57) ABSTRACT

A power storage cell includes an electrode body in which a sheet member is wound surrounding a winding axis, and a housing case in which the electrode body is housed. The electrode body includes a starting terminal portion in a winding direction, and an ending terminal portion located on an opposite side from the starting terminal portion. The sheet member includes an electrode sheet and a separator. The electrode sheet includes a current collector plate and an electrode composite material layer formed on the current collector plate. The electrode sheet includes a first portion located in one winding portion from the starting terminal portion, and a second portion located on the ending terminal portion side from the first portion. A thickness of the electrode composite material layer located in the first portion is smaller than a thickness of the electrode composite material layer located in the second portion.

### CROSS-REFERENCE TO RELATED APPLICATION

This application claims priority to Japanese Patent Application No. 2023-086722 filed on May 26, 2023, incorporated herein by reference in its entirety.

### BACKGROUND

### 1. Technical Field

The present disclosure relates to a power storage cell.

### 2. Description of Related Art

Japanese Patent No. 4805545 discloses a lithium secondary battery including an internal electrode body of a wound type, in which an anode metal foil body and a cathode metal foil body are formed with a separator interposed therebetween. The internal electrode body is formed by winding an anode sheet, a separator, and a cathode sheet.

The anode sheet includes an anode current collector plate and an anode composite material layer formed on the anode current collector plate. The cathode sheet includes a cathode current collector plate and a cathode composite material layer formed on the cathode current collector plate.

### SUMMARY

The electrode body of the lithium secondary battery configured as described above is formed by winding the sheets.

A winding radius is small at a winding center side of the electrode body, for example. As a result, the winding radius of the anode composite material layer of the anode sheet is also small on the winding center side thereof, and the anode composite material layer may peel off, cracks may occur in the anode composite material layer, and so forth. Note that a similar problem also occurs in the cathode composite material layer of the cathode sheet.

The present disclosure has been made in view of the above-described problems, and an object thereof is to provide a power storage cell in which occurrence of cracks or the like in electrode composite material layers is suppressed.

A power storage cell includes an electrode body in which a sheet member is wound surrounding a winding axis, and a housing case in which the electrode body is housed. The electrode body includes a starting terminal portion in a winding direction, and an ending terminal portion located on an opposite side from the starting terminal portion. The sheet member includes an electrode sheet and a separator. The electrode sheet includes a current collector plate and an electrode composite material layer formed on the current collector plate. The electrode sheet includes a first portion located in one winding portion from the starting terminal portion, and a second portion located on the ending terminal portion side from the first portion. A thickness of the electrode composite material layer located in the first portion is smaller than a thickness of the electrode composite material layer located in the second portion.

The electrode sheet includes an anode sheet and a cathode sheet. The anode sheet includes an anode current collector and an anode composite material layer formed on the anode current collector. The cathode sheet includes a cathode current collector and a cathode composite material layer formed on the cathode current collector. In at least one of the anode composite material layer and the cathode composite material layer, the thickness of the first portion is smaller than the thickness of the second portion.

The anode composite material layer is fashioned to become thinner from the ending terminal portion toward the starting terminal portion. The cathode composite material layer is fashioned to become thinner from the ending terminal portion toward the starting terminal portion. A ratio between the thickness of the anode composite material layer and the thickness of the cathode composite material layer is constant from the ending terminal portion to the starting terminal portion. The thickness of the cathode composite material layer is greater than the thickness of the anode composite material layer at the same position in the winding direction. The thickness of the electrode composite material layer located in the first portion is an average thickness of the thickness of the electrode composite material layer located in the first portion. The thickness of the electrode composite material layer located in the second portion is an average thickness of the thickness of the electrode composite material layer located in the second portion.

According to the power storage cell of the present disclosure, occurrence of cracks and so forth in the electrode composite material layer can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a power storage cell 1 according to the present embodiment;

FIG. 2 is a perspective view schematically showing the electrode body 10;

FIG. 3 is a plan view showing the anode sheet 22;

FIG. 4 is a plan view showing the cathode sheet 24;

FIG. 5 is an expanded view showing a state in which the sheet member 20 is expanded and the respective sheets are arranged;

FIG. 6 is a cross-sectional view showing the anode sheet 22 and the cathode sheet 24, and the separator 21 and the separator 23;

FIG. 7 is a cross-sectional view showing the cathode sheet 24A of the power storage cell 1A, the separator 23, the anode sheet 22A, and the separator 21; and

FIG. 8 is a cross-sectional view showing the cathode sheet 24B of the power storage cell 1B, the separator 23, the anode sheet 22B, and the separator 21.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

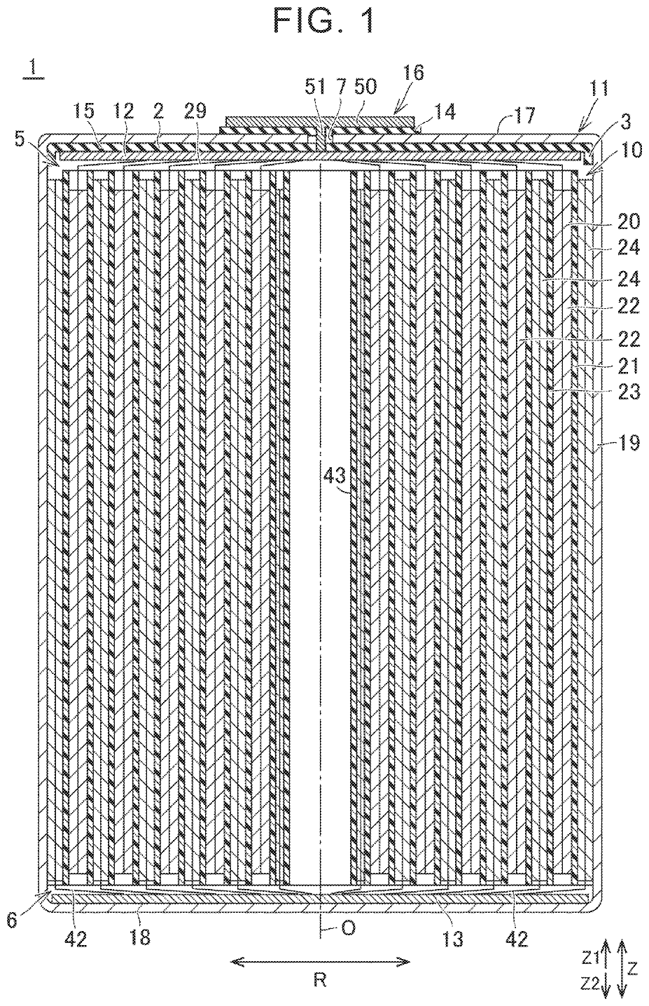

FIG. 1 is a cross-sectional view showing a power storage cell 1 according to the present embodiment. The power storage cell 1 includes a cylindrical electrode body 10 formed so as to surround the winding axis O, a case 11, an anode current collector member 12, a cathode current collector member 13, insulating members 14 and 15, and an anode terminal 16.

In FIG. 1 and the like, “Z” indicates a direction in which the winding axis O extends. “Z1” denotes one direction in the Z-direction. “Z2” refers to the other direction in the Z-direction. “R” indicates the radial direction of the electrode body 10.

The case 11 includes a top plate 17, a bottom plate 18, and a peripheral wall 19. The case 11 is made of a metal material. The top plate 17 is located at one end of the case 11. The bottom plate 18 is located at the other end of the case 11. The peripheral wall 19 is disposed between the top plate 17 and the bottom plate 18.

A through hole 7 is formed in the top plate 17. The insulating member 14 is disposed on the outer surface of the top plate 17. A through-hole is formed in the insulating member 14.

The insulating member 15 includes a top plate portion 2 and a peripheral wall 3 provided at an outer peripheral edge portion of the top plate portion 2. The top plate portion 2 is disposed on the inner surface of the top plate 17. The peripheral wall 3 is disposed on an inner peripheral surface of the peripheral wall 19. A through-hole is formed in the top plate 17.

The anode terminal 16 includes a flat plate 50 and a shaft 51. The flat plate 50 is disposed on the insulating member 14. The shaft 51 is connected to the flat plate 50 and is formed so as to extend toward Z2. The shaft 51 is inserted into the case 11 through a through-hole formed in the insulating member 14, a through-hole 7, and a through-hole formed in the insulating member 15.

The anode current collector member 12 is disposed Z2 to the insulating member 15. The anode current collector member 12 is formed in a plate shape. A lower terminal portion of the shaft 51 is welded to an upper surface of the anode current collector member 12. The anode current collector member 12 is made of, for example, aluminum.

The cathode current collector member 13 is disposed on the inner surface of the bottom plate 18. The cathode current collector member 13 is formed in a plate shape. The cathode current collector member 13 is made of a metal material such as copper.

The electrode body 10 is disposed between the anode current collector member 12 and the cathode current collector member 13 in the case 11.

The electrode body 10 includes an Z1 terminal portion 5. An anode current collector member 12 is disposed at the terminal portion 5. The electrode body 10 includes an Z2 terminal portion 6. The cathode current collector member 13 is disposed at the terminal portion 6. The electrode body 10 is formed in a hollow shape, and a hollow portion 43 is formed. The hollow portion 43 is formed at a position passing through the winding axis O.

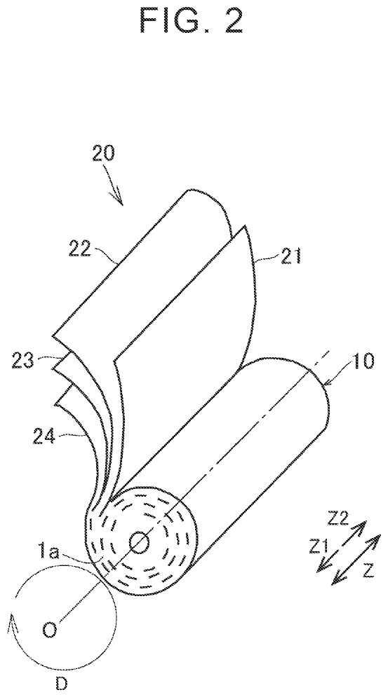

FIG. 2 is a perspective view schematically showing the electrode body 10. The electrode body 10 includes a sheet member 20 formed so as to surround the winding axis O. Note that “D” is a direction in which the sheet member 20 extends in the electrode body 10 in the wound state.

The sheet member 20 is formed to be long in the winding direction D of the electrode body 10. The sheet member 20 includes a separator 21, an anode sheet 22, a separator 23, and a cathode sheet 24.

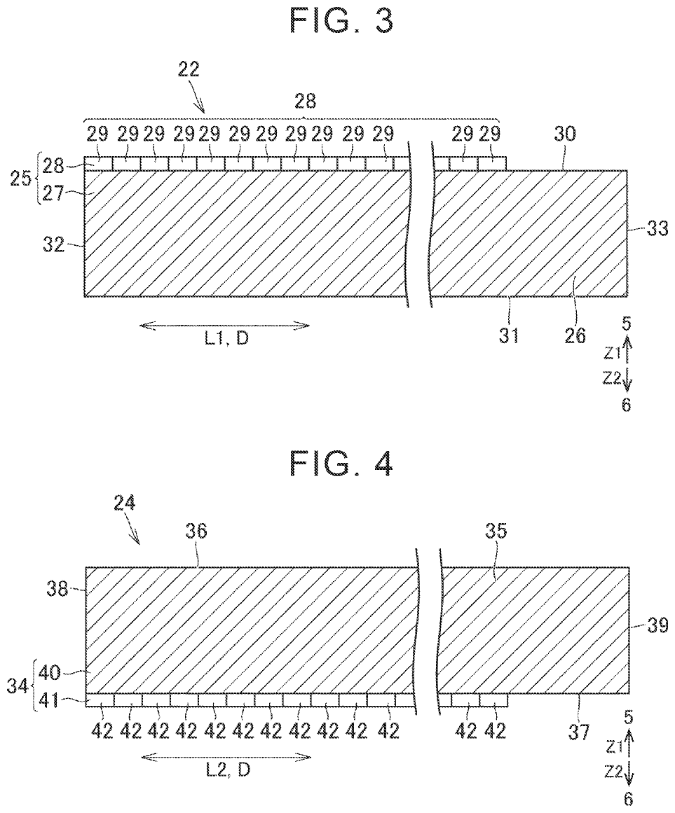

FIG. 3 is a plan view showing the anode sheet 22. The anode sheet 22 shown in FIG. 3 is dismantled from a state of being wound around the electrode body 10, and is in an expanded state. The anode sheet 22 includes a long side 30, a long side 31, and short sides 32 and 33. The long sides 30 and 31 extend in L1 in which the anode current collector plate 25 extends. L1 direction corresponds to the winding direction D in the condition of the wound electrode body 10. The long side 30 is positioned at the terminal portion 5 of the electrode body 10 in the wound state. The long side 31 is located at the terminal portion 6 of the electrode body 10 in a wound state.

The anode sheet 22 includes an anode current collector plate 25 and an anode composite material layer 26. The anode current collector plate 25 is made of, for example, a metal material such as aluminum or an aluminum alloy.

The anode composite material layer 26 includes an anode active material, a binder, and the like. The anode active material, for example, LiCoO₂, LiNo₂, LiMn₂O₄, and the like. The thickness of the anode composite material layer 26 is, for example, 0.1 μm or more and 1000 μm or less.

The anode current collector plate 25 includes a coating portion 27 on which the anode composite material layer 26 is formed, and an uncoated portion 28 on which the anode composite material layer 26 is not formed. The anode composite material layer 26 is formed from the short side 33 to the short side 32. The anode composite material layer 26 is formed on both the front and back surfaces of the anode current collector plate 25, but the anode composite material layer 26 may be formed on one surface. The uncoated portion 28 is formed on the long side 30. The uncoated portion 28 includes a plurality of anode metallic pieces 29 arranged in L1 direction.

FIG. 4 is a plan view showing the cathode sheet 24. The cathode sheet 24 shown in FIG. 4 is disassembled from a state of being wound around the electrode body 10 and is in an expanded state. The cathode sheet 24 includes a cathode current collector plate 34 and a cathode composite material layer 35. The cathode sheet 24 includes a long side 36, a long side 37, and short sides 38 and 39. The long sides 36 and 37 extend in L2 in which the cathode sheet 24 extends. The long side 36 is located at the terminal portion 5 of the electrode body 10 in a wound state. The long side 37 is located at the terminal portion 6 of the electrode body 10 in a wound state.

The cathode composite material layer 35 is formed from the short side 39 to the short side 38. The cathode composite material layer 35 includes a cathode active material, a binder, and the like. The cathode active material is graphite or the like. The thickness of the cathode composite material layer 35 is, for example, 0.1 μm or more and 1000 μm or less.

The cathode current collector plate 34 includes a metal material such as copper. The cathode current collector plate 34 includes a coating portion 40 on which the cathode composite material layer 35 is formed, and an uncoated portion 41 on which the cathode composite material layer 35 is not formed. The uncoated portion 41 is formed on the long side 37. The uncoated portion 41 includes a plurality of cathode metallic pieces 42 arranged in L2 direction.

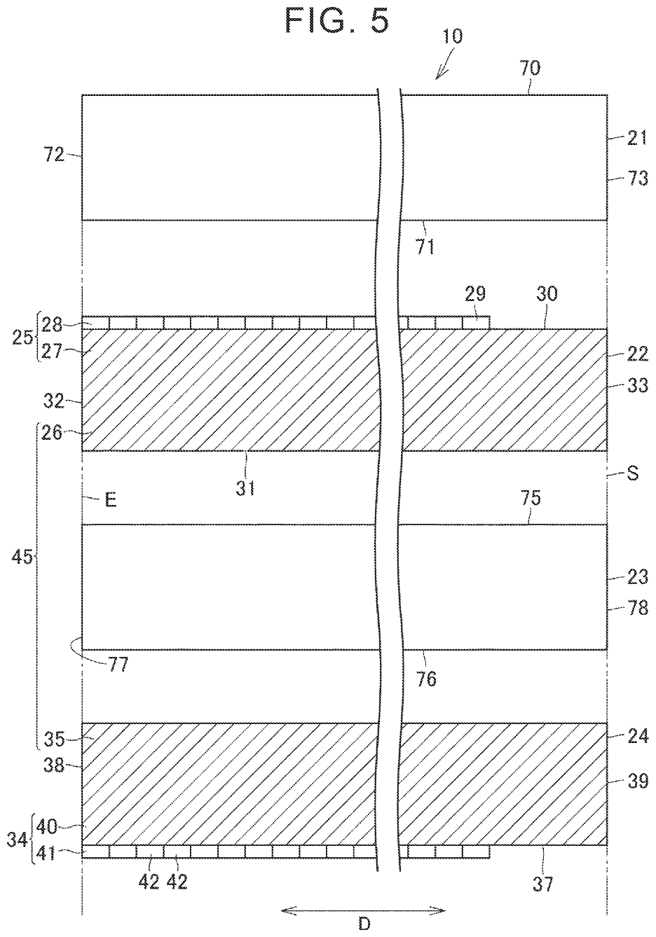

FIG. 5 is an expanded view showing a state in which the sheet member 20 is expanded and the respective sheets are arranged. The sheet member 20 is formed by stacking the separator 23 on the cathode sheet 24, stacking the anode sheet 22 on the separator 23, and stacking the separator 21 on the anode sheet 22. The positions of the cathode sheet 24 and the anode sheet 22 may be interchanged.

The separator 21 and the separator 23 are formed to be long. The separator 21 includes long sides 70 and 71 and short sides 72 and 73. The separator 23 includes long sides 75 and 76 and short sides 77 and 78.

In FIG. 5, the electrode body 10 includes an electrode composite material layer 45. The electrode composite material layer 45 includes an anode composite material layer 26 and a cathode composite material layer 35. “S” represents the starting terminal portion S located on the winding axis O side in the electrode composite material layer 45. “E” indicates the ending terminal portion E located on the opposite side of the starting terminal portion S in the electrode composite material layer 45.

In the example shown in FIG. 5, the short side 33 and the short side 39 are located at the starting terminal portion S. The short side 32 and the short side 38 are located at the ending terminal portion E. The short side 33 and the short side 39 may be shifted in the winding direction D. In this case, in the wound state, the side closer to the winding axis O becomes the starting terminal portion S. Similarly, when the short side 32 and the short side 38 are shifted in the winding direction D, the side away from the winding axis O is the ending terminal portion E. In the example shown in FIG. 5, the short sides 73 and 78 of the separators 21 and 23 are also located at the starting terminal portion S. The short sides 72 and 73 are also located at the ending terminal portion E. On the other hand, the separators 21 and 23 may be formed longer in the winding direction D than the anode sheet 22 and the cathode sheet 24.

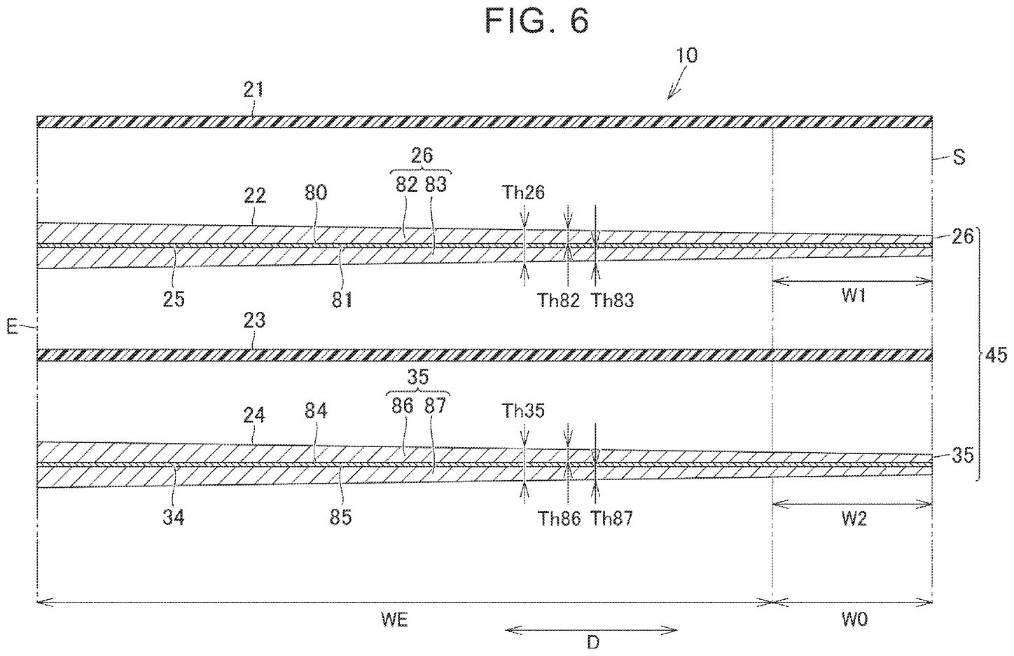

FIG. 6 is a cross-sectional view showing the anode sheet 22 and the cathode sheet 24, and the separator 21 and the separator 23. The anode current collector plate 25 includes a main surface 80 and a main surface 81. The anode composite material layer 26 includes a one-side anode composite material layer 82 formed on the main surface 80 and a one-side anode composite material layer 83 formed on the main surface 81.

Here, the thickness Th26 of the anode composite material layer 26 is the sum thickness of the thickness Th82 of the one-side anode composite material layer 82 and the thickness Th83 of the one-side anode composite material layer 83. The thickness is a thickness in a direction perpendicular to the main surfaces 80 and 81.

The cathode current collector plate 34 includes a main surface 84 and a main surface 85. The cathode composite material layer 35 includes a one-side cathode composite material layer 86 formed on the main surface 84 and a one-side cathode composite material layer 87 formed on the main surface 85.

The thickness Th35 of the cathode composite material layer 35 is the sum of the thickness Th86 of the one-side cathode composite material layer 86 and the thickness Th87 of the one-side cathode composite material layer 87.

“W0” is a one winding portion W0 indicating a portion from the starting terminal portion S to one turn in the electrode-composite material layer 45. “WE” indicates a portion WE of the electrode-composite material layer 45 located closer to the ending terminal portion E than the one winding portion W0.

The first portion W1 is a portion of the anode composite material layer 26 located on the one winding portion W0. The second portion W2 is a portion of the cathode composite material layer 35 located on the one winding portion W0.

The thickness of the electrode composite material layer 45 is the sum of the thickness Th26 of the anode composite material layer 26 and the thickness Th35 of the cathode composite material layer 35.

The thickness of the electrode composite material layer 45 located on the one winding portion W0 is smaller than the thickness of the electrode composite material layer 45 located on the portion WE.

The electrode body 10 is formed so as to surround the periphery of the winding axis O from the starting terminal portion S. Therefore, in the wound electrode body 10, the radius of curvature Rs of the one winding portion W0 is smaller than the radius of curvature Re of the portion WE.

Therefore, cracks may occur in the electrode composite material layer 45 in the one winding portion W0. On the other hand, in the power storage cell 1 according to the present embodiment, since the thickness of the electrode composite material layer 45 located on the one winding portion W0 is thinner than the thickness of the electrode composite material layer 45 located on the portion WE, the occurrence of cracks or the like in the electrode composite material layer 45 is suppressed.

The thickness Th26 of the anode composite material layer 26 is formed so as to be thinner from the ending terminal portion E toward the starting terminal portion S. The thickness Th82, Th83 is also formed so as to be thinner from the ending terminal portion E toward the starting terminal portion S.

The radius-of-curvature Rs of the one winding portion WO becomes smaller as it is closer to the starting terminal portion S. Therefore, the thickness Th26 is formed so as to be thinner from the ending terminal portion E toward the starting terminal portion S, thereby preventing cracks and the like from occurring in the anode composite material layer 26 and the one-side anode composite material layers 82 and 83.

The thickness Th35 of the cathode composite material layer 35 is formed so as to be thinner from the ending terminal portion E toward the starting terminal portion S. The thickness Th86, thickness Th87 is also formed so as to be thinner from the ending terminal portion E toward the starting terminal portion S. Therefore, the occurrence of cracks and the like is also suppressed in the cathode composite material layer 35 and the one-side cathode composite material layers 86 and 87.

From the ending terminal portion E to the starting terminal portion S, the thickness Th26 and the thickness Th35 are constant. Note that “constant” means that the difference in ratio is, for example, 0.1 or less. Thus, even if the power storage cell 1 repeats charging and discharging, it is possible to suppress the occurrence of lithium deposition.

In the same position in the winding direction D, the thickness Th35 of the cathode composite material layer 35 is formed to be larger than the thickness Th26 of the anode composite material layer 26. This makes it possible to favorably suppress the occurrence of lithium deposition.

In the above-described embodiment, both of the anode composite material layer 26 and the cathode composite material layer 35 are formed so as to be thin in one winding portion W0. However, at least one of the anode composite material layer 26 and the cathode composite material layer 35 may be made thin. For example, by making only the anode composite material layer 26 thin, the thickness of the electrode composite material layer 45 may be made thin in one winding portion W0.

### Modification 1

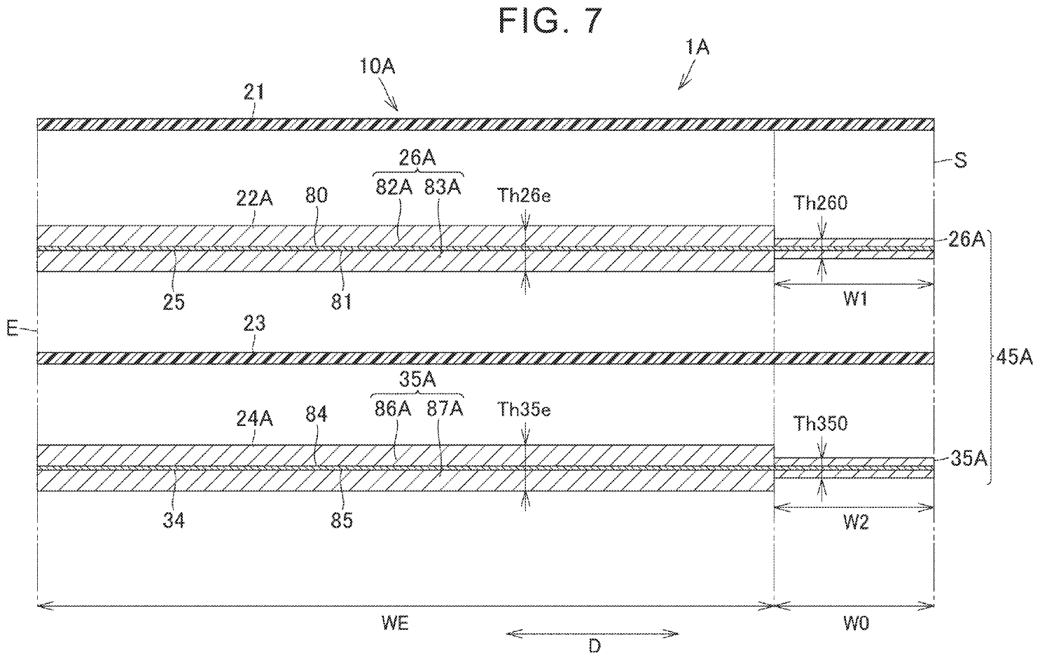

A power storage cell 1A according to Modification 1 will be described with reference to FIG. 7. FIG. 7 is a cross-sectional view showing the cathode sheet 24A of the power storage cell 1A, the separator 23, the anode sheet 22A, and the separator 21.

The electrode composite material layer 45A includes an anode composite material layer 26A and a cathode composite material layer 35A. The thickness of the electrode composite material layer 45A is formed such that the thickness of the portion located on the one winding portion W0 is thinner than the thickness of the portion located on WE of the portion.

As a result, in the electrode body 10A which is wound, cracks are prevented from occurring in the anode composite material layer 26A and the cathode composite material layer 35A on the one winding portion W0.

The thickness Th260 of the anode composite material layer 26A located on the one winding portion W0 is constant. The thickness Th350 of the cathode composite material layer 35A located on the one winding portion W0 is also constant.

The anode composite material layer 26A located on the portion WE has a constant thickness Th26e, and the cathode composite material layer 35A located on the portion WE has a constant thickness Th35e.

The thickness Th260 is thinner than the thickness Th26e, and the thickness Th350 is thinner than Th35e. As a result, in both the anode composite material layer 26A and the cathode composite material layer 35A, it is possible to suppress the occurrence of cracks or the like in the one winding portion W0.

### Modification 2

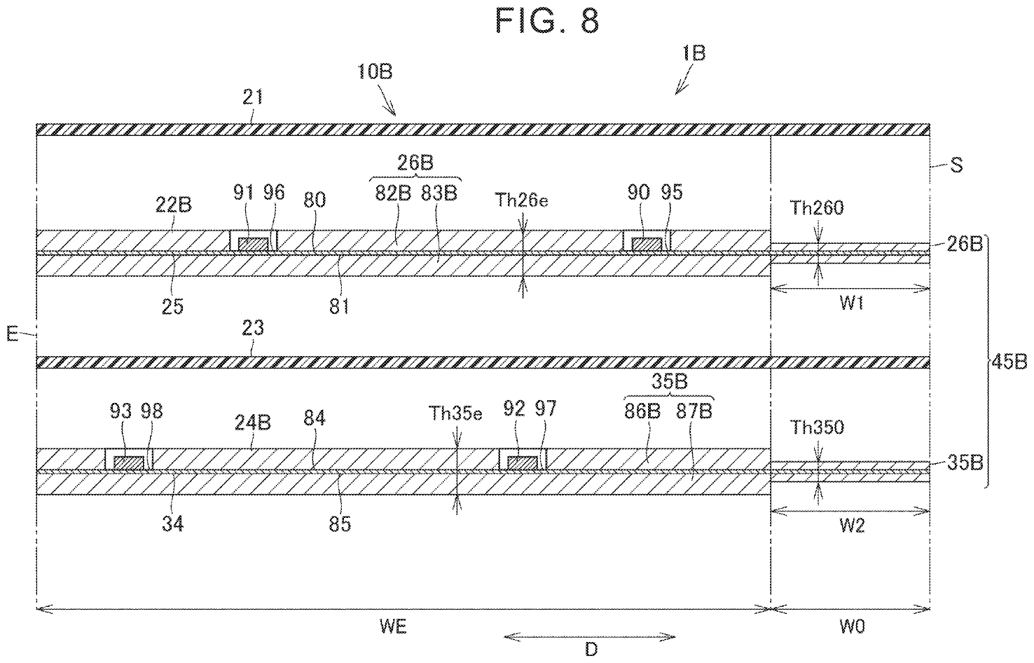

A power storage cell 1B according to Modification 2 will be described with reference to FIG. 8. FIG. 8 is a cross-sectional view showing the cathode sheet 24B of the power storage cell 1B, the separator 23, the anode sheet 22B, and the separator 21.

The power storage cell 1B includes anode tabs 90 and 91 and cathode tabs 92 and 93. The anode tabs 90 and 91 are provided on the anode sheet 22B.

An exposed portion 95 and an exposed portion 96 are formed in the one-side anode composite material layer 82 of the anode sheet 22B. In the exposed portions 95 and 96, the one-side anode composite material layer 82 is not formed, and a part of the main surface 80 is exposed.

An exposed portion 97 and an exposed portion 98 are formed in the one-side cathode composite material layer 86 of the cathode sheet 24B. In the exposed portions 97 and 98, the one-side cathode composite material layer 86 is not formed, and the main surface 84 is exposed. The anode tabs 90 and 91 are connected to the main surface 80 located at the exposed portions 95 and 96. The cathode tabs 92 and 93 are connected to the main surface 84 located at the exposed portions 97 and 98.

In the embodiment shown in the power storage cell 1B, a portion where the composite material layer is thin is formed on the portion WE, but the average thickness of the electrode composite material layer 45B located on the first portion W1 is thinner than the average thickness of the electrode composite material layer 45B located on the portion WE.

Therefore, even in the power storage cell 1B, it is possible to suppress the occurrence of a crack or the like in the one winding portion W0 of the electrode composite material layer 45B.

It should be considered that the embodiment described herein is just an example in all respects and is not limitative. It is intended that the present disclosure be defined by the claims and that all changes within the meaning and range of equivalency of the claims be embraced therein.

What is claimed is:

1. A power storage cell comprising:
an electrode body in which a sheet member is wound surrounding a winding axis; and
a housing case in which the electrode body is housed, wherein:
the sheet member includes an electrode sheet and a separator;
the electrode sheet includes a current collector plate and an electrode composite material layer formed on the current collector plate;
the electrode composite material layer includes a starting terminal portion in a winding direction, an ending terminal portion located on an opposite side from the starting terminal portion, a first portion located in one winding portion from the starting terminal portion, and a second portion located on the ending terminal portion side from the first portion; and
a thickness of the electrode composite material layer located in the first portion is smaller than a thickness of the electrode composite material layer located in the second portion.

2. The power storage cell according to claim 1, wherein:
the electrode sheet includes an anode sheet and a cathode sheet;
the anode sheet includes an anode current collector and an anode composite material layer formed on the anode current collector;
the cathode sheet includes a cathode current collector and a cathode composite material layer formed on the cathode current collector; and
in at least one of the anode composite material layer and the cathode composite material layer, the thickness of the first portion is smaller than the thickness of the second portion.

3. The power storage cell according to claim 2, wherein:
the anode composite material layer is fashioned to become thinner from the ending terminal portion toward the starting terminal portion; and
the cathode composite material layer is fashioned to become thinner from the ending terminal portion toward the starting terminal portion.

4. The power storage cell according to claim 3, wherein a ratio between the thickness of the anode composite material layer and the thickness of the cathode composite material layer is constant from the ending terminal portion to the starting terminal portion.

5. The power storage cell according to claim 2, wherein the thickness of the cathode composite material layer is greater than the thickness of the anode composite material layer at the same position in the winding direction.

6. The power storage cell according to claim 1, wherein:
the thickness of the electrode composite material layer located in the first portion is an average thickness of the thickness of the electrode composite material layer located in the first portion; and
the thickness of the electrode composite material layer located in the second portion is an average thickness of the thickness of the electrode composite material layer located in the second portion.
